(19) United States
(12) Patent Application Publication
(10) Pub. No.: US 2023/0267534 A1
(43) Pub. Date: Aug. 24, 2023

(54) BUSINESS-TO-BUSINESS (B2B) CANNABIS ONLINE MARKETPLACE SYSTEM AND METHOD

(71) Applicant: Ara Gulesserian, Glendale, CA (US)

(72) Inventor: Ara Gulesserian, Glendale, CA (US)

(21) Appl. No.: 18/092,168

(22) Filed: Dec. 30, 2022

Related U.S. Application Data
(60) Provisional application No. 63/294,849, filed on Dec. 30, 2021.

(51) Int. Cl. G06Q 30/08; G06Q 20/10; G06Q 30/0282; G06Q 10/083; G06Q 30/018; G06Q 10/0639; G06Q 30/0601

(52) U.S. Cl. CPC G06Q 30/08; G06Q 20/108; G06Q 30/0282; G06Q 10/083; G06Q 30/018; G06Q 10/0639; G06Q 30/0609

(57) ABSTRACT

An online business-to-business (B2B) cannabis marketplace comprising includes a search module to allow cannabis buyers to be able to find cannabis sellers or growers; an auction module to allow cannabis sellers to hold an auction to sell the seller's cannabis products; a payment module to handle payment tracking and payment processing for the seller's cannabis products; an escrow account module to keep track of escrow deposits of currency by sellers or buyers and/or deposits of cannabis products by sellers in the online B2B cannabis marketplace; a rating module to allow the cannabis buyers to provide ratings for the cannabis sellers; a transportation module to coordinate shipping of purchased cannabis products from the cannabis seller to the cannabis buyer; an administration module to allow for the operator of the online B2B cannabis marketplace in order for the operator to ensure acceptable operation of the marketplace.

### RELATED APPLICATION

This patent application claims priority to application Ser. No. 63/294,849, filed Dec. 30, 2021, the entirety of which is hereby incorporated by reference.

### BACKGROUND

The number of cannabis growers has grown significantly as cannabis is legalized in more and more states. At times, the amount of cannabis available in the local market is larger than the amount of cannabis desired by consumers and/or dispensaries. In these cases, cannabis growers utilize word of mouth to let out-of-area dispensaries or distributors know that the excess cannabis product is available. This presents problems for growers and adds additional expense because they may need to contact a large number of potential distributors or dispensaries in order to make a sale and this has to be done in a short amount of time because cannabis has a short product lifetime.

Therefore, a need exists for an online marketplace where cannabis distributors or dispensaries and/or cannabis growers can connect with each other in order to move the excess product. In this patent application, the cannabis distributors or dispensaries may be referred to as buyers or purchasers because they are buying from growers or sellers and then sending to consumers.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 illustrates a block diagram of the B2B Cannabis online marketplace;

FIG. 2A illustrates a block diagram of a cannabis marketplace according to some embodiments;

FIG. 2B illustrates a buyer or purchaser module according to some embodiments;

FIG. 2C illustrates a seller or grower module according to some embodiments;

FIG. 3 illustrates a transaction module 300 according to some embodiments;

FIG. 4 illustrates a method of establishing legitimacy of a buyer according to some embodiments;

FIG. 5 illustrates a method of cannabis marketplace verifying a seller or grower according to some embodiments; and

FIG. 6 illustrates a method of operating an online cannabis marketplace according to some embodiments.

### DETAILED DESCRIPTION

The following detailed description and provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

The system and method described herein is a business-to-business online marketplace for distributors or dispensaries and/or growers to buy and/or sell large amount of cannabis product. This is not a consumer marketplace for buying cannabis products for personal use. This is business-to-business (B2B) online marketplace located on cloud-based computing devices or servers where large purchases of cannabis products may take place between licensed businesses. In the specification, the marketplace may be referred to as the B2B Cannabis online marketplace, although other similar names may be utilized.

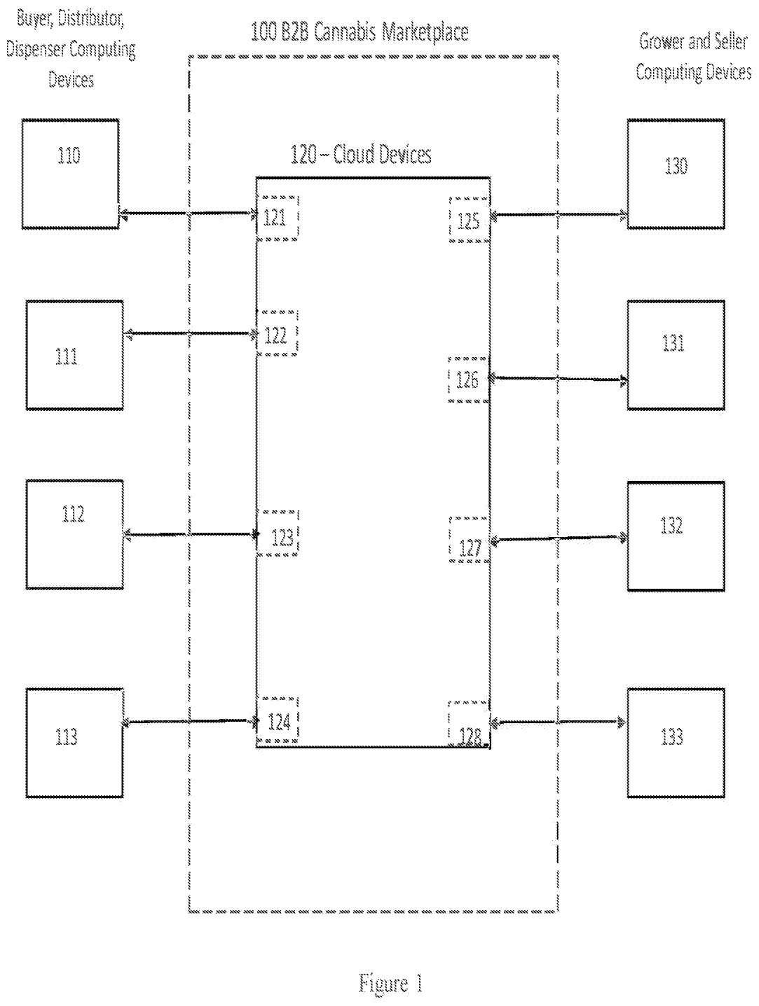

FIG. 1 illustrates a block diagram of the B2B Cannabis online marketplace. In some embodiments, the B2B Cannabis online marketplace 100 may include one or more cloud-computing devices or servers 120, one or more distributor or dispensary computing devices 110, 111, 112, or 113, and/or one or more grower computing devices 130, 131, 132, or 133. In these embodiments, each of the distributor or dispensary computing devices 110, 111, 112, or 113 may be associated with or correspond to an account 121 122 123 or 124 on the B2B Cannabis cloud computing devices or servers 120 and each of grower computing devices 130, 131, 132, or 133 may be associated with or correspond to an account 125 126 127 or 128 on the B2B Cannabis cloud computing devices or servers 120. Each of the buyer's or seller's account may include a buyer profile and/or a seller profile. Although only eight computing devices and/or accounts are shown, this B2B Cannabis online marketplace may also include many more (from 5 to 10,000 devices and/or users) distributor or dispensary computing devices (and associated accounts) and/or many more (from 5 to 10,000 devices seller or grower computing devices (and associated accounts). Although the description here describes a cannabis B2B online marketplace, the specification and claimed subject matter also applies to other regulated medical products and agricultural products, such as tobacco, hemp, gummies, or other products under FDA control. In other words, other agricultural products may be sold and/or bought on the cannabis B2B online marketplace.

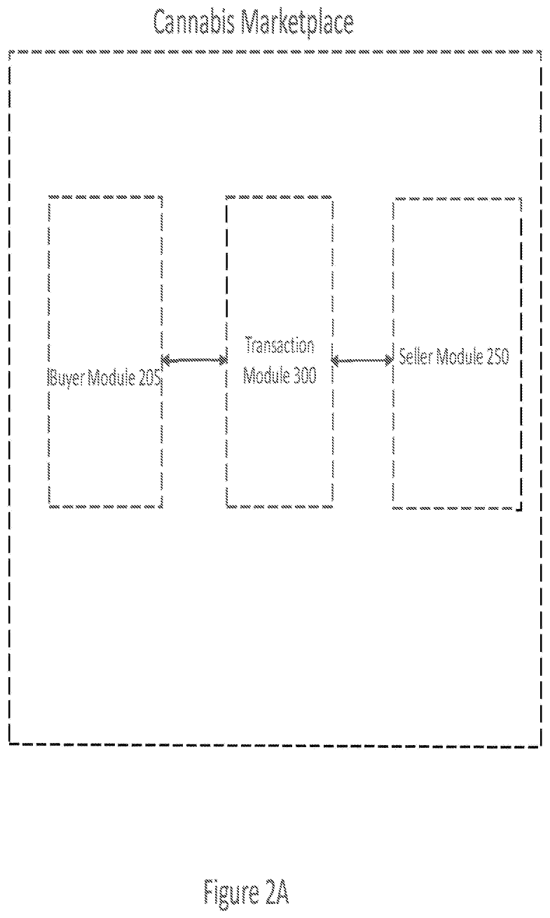

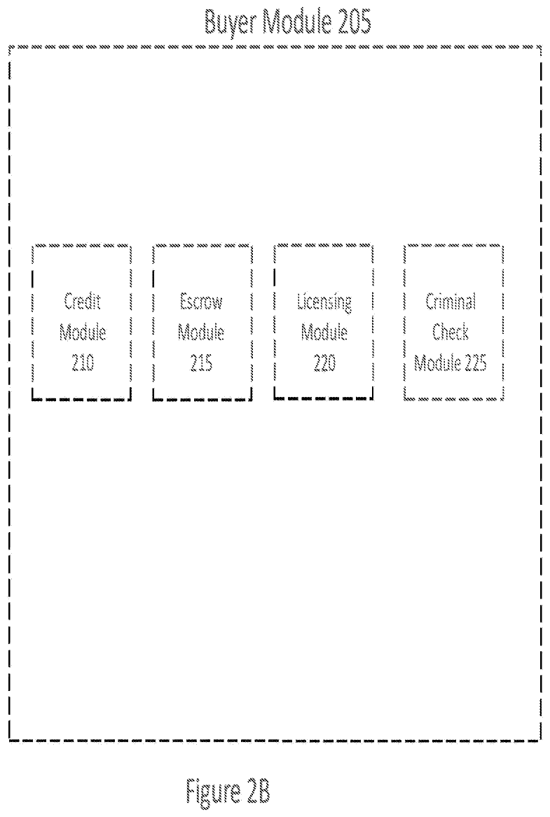

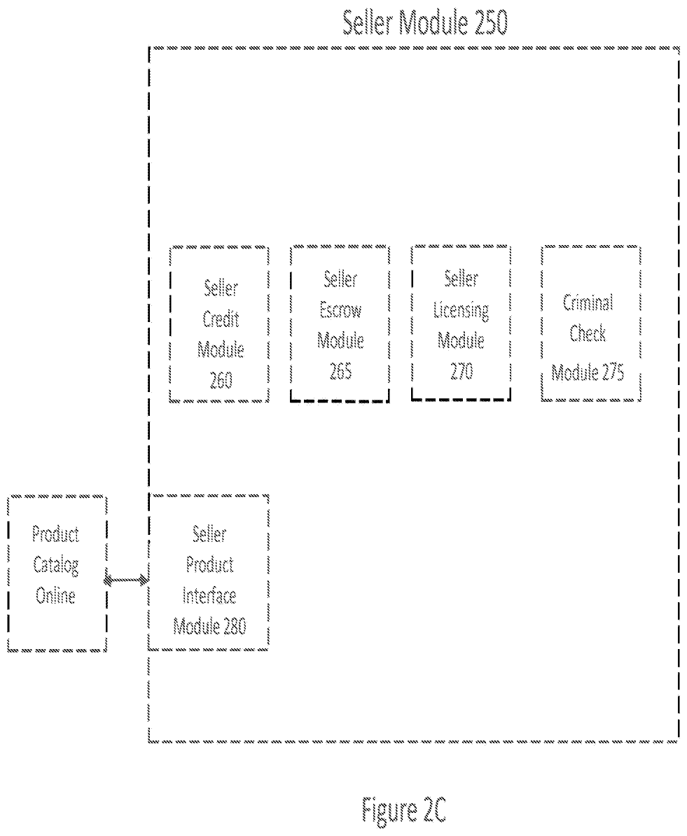

FIG. 2A illustrates a block diagram of a cannabis marketplace according to some embodiments. In some embodiments, the buyer's account in the buyer module 205 may include buyer profile information, as well as a unique name and/or identification value. In some embodiments, the buyer profile information may include personal and/or business information including buyer name, buyer address, buyer shipping address and/or buyer financial account information. In some embodiments, the buyer financial account information may be bank account information, investment (e.g., mutual fund, money market, brokerage) account information and/or cryptocurrency account information. The B2B Cannabis online marketplace needs to keep the buyer account profile information private so that marijuana growers or sellers do not have access to this information, as well as keep other buyer's from gaining access to this information. The owner and/or the operator of the B2B Cannabis online marketplace is the only entity that has access to both the buyer and/or seller profile information. The only information that may be available to the seller or grower is the unique buyer name and/or the unique buyer identification value. Thus, in some embodiments, a buyer on a buyer computing device may be identified only via the unique name and/or unique identification during cannabis transactions (e.g., purchasing cannabis products). In some embodiments, the B2B Cannabis online marketplace may also include a transaction module 300 and/or a seller module 250.

FIG. 2B illustrates a buyer or purchaser module according to some embodiments. In some embodiments, the B2B Cannabis online marketplace may need to verify the buyer is authentic and/or licensed in order to allow the buyer or purchaser to purchase products on the B2B Cannabis online marketplace. In some embodiments, the buyer's module 205 may need to verify that the buyer has the necessary funds and/or liquidity in order to transact business on the B2B Cannabis online marketplace. In some embodiments, the buyers' module 205 may include a credit module 210 to verify credit worthiness of the buyer or the purchaser of the cannabis products. In some embodiments, the credit module 210 may reject buyers or purchasers who do not maintain a specific credit rating threshold and/or do not have a bank or other financial institution that will stand behind them and provide funds if the buyer or purchaser itself cannot. In some embodiments, the buyer's module 205 may include an escrow account module or an escrow account link 215 where the buyer or purchaser may have to deposit currency in order to engage in transactions in the B2B Cannabis online marketplace.

The currency may be fiat currency (e.g., US dollars or other nation's currency) and/or may be cryptocurrency. In some embodiments, the purchaser or buyer may have deposit $30,000 in currency in order to register with B2B Cannabis online marketplace, although larger currency escrow deposits may be required depending on the type of transactions the buyer and/or purchaser engage in. In some embodiments, the buyer's module 205 may include a licensing module 220. In some embodiments, the licensing module 220 may automatically contact city, county, state, and/or federal licensing agencies (through respective and/or associated computing devices) to verify that the buyer or purchaser has the proper city, county, state and/or federal requirements for selling and/or distributing cannabis. In some embodiments, if online verification with licensing authorities is not available, the licensing module 220 may request that the buyer or purchaser enter and/or upload licensing information and/or certificates to the licensing module 220 of the buyer's module. In these embodiments, the buyer licensing module 220 may then analyze the entered and/or uploaded information in order to verify the buyer or purchaser meets all licensing requirements of the city, state and/or nation in which the buyer or dispensary is operating. In some embodiments, the criminal check module 225 of the buyer module 205 may verify that the buyer or purchaser (and any employees thereof) has a clean criminal record by running a background check and/or an FBI background check.

In some embodiments, if the buyer or purchaser meets all of the above-identified requirements and positive reports are received from the buyer credit module 210, the buyer escrow module 215, the buyer licensing module 220 and/or the buyer criminal check module 225, then the buyer module 205 may authenticate and/or approve the buyer or purchaser as an entity or individual that may engage in transactions on the B2B Cannabis online marketplace. In some embodiments, the buyer or purchaser module 205 may be a mobile computing device software application (mobile app) that communicates and/or interacts with one or more cloud-based computing devices 120 of the B2B Cannabis online marketplace. In some embodiments, the buyer module 205 (and associated credit module 210, escrow module 215, licensing module 220 and/or criminal check module 225) may be computer-readable instructions stored in one or more memory devices and executable by one or more processors or controllers in order to provide the functionality described herein. All modules describe herein may be computer-readable instructions stored in one or more memory devices and executable by one or more processors or controllers in order to provide the functionality described herein.

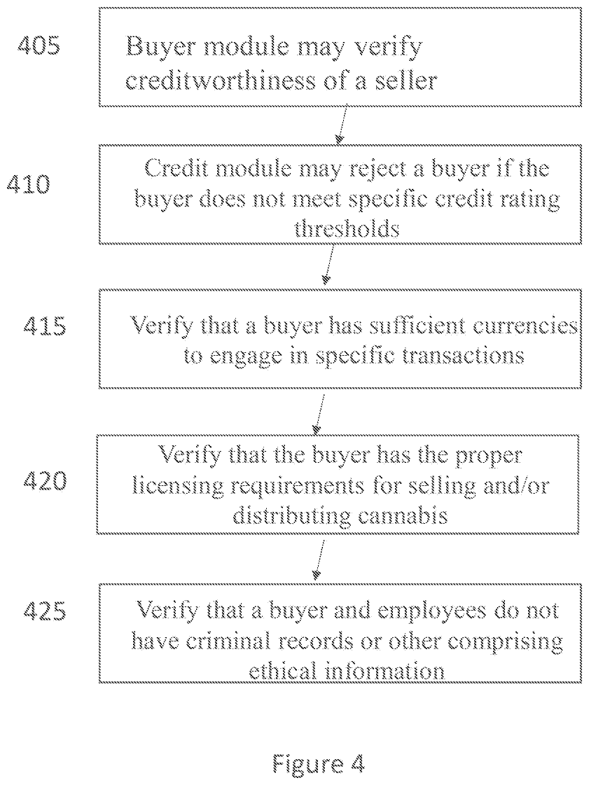

FIG. 4 illustrates a method of establishing legitimacy of a buyer according to some embodiments. In some embodiments, in step 405, a buyer module may verify creditworthiness of a seller by checking a credit score of a buyer. In some embodiments, in step 410, the credit module may reject a buyer if the buyer does not meet specific credit rating thresholds or have a bank or financial institution to stand behind the buyer. In some embodiments, in step 415, an escrow module 215 may verify that a buyer has sufficient currencies to engage in specific transactions. This may occur by the escrow module 415 checking third-party financial institution computing devices for balances and/or lines of credits. In some embodiments, in step 420, a licensing module 220 may automatically contact city, county, state, and/or federal licensing agencies (through respective and/or associated computing devices) to verify that the buyer or purchaser has the proper city, county, state and/or federal requirements for selling and/or distributing cannabis. In an alternative embodiment, the licensing module may verify uploaded licensing information from the seller in order to verify the buyer or purchaser has the proper licenses and requirement. In some embodiments, in step 425, a criminal check module 225 may verify that a buyer or purchaser (and/or associated employees) do not have criminal records or other comprising ethical information.

FIG. 2C illustrates a seller or grower module according to some embodiments. In some embodiments, the seller or grower module 250 may include a seller or grower profile for each seller account that is located in the B2B cannabis online marketplace, as well as a unique seller name and/or seller identification value for each seller account. In some embodiments, the seller or grower profile information may include personal and/or business information including seller name, seller address, seller business address, seller growing address and/or seller warehouse address, and/or seller financial account information. In some embodiments, the seller financial account information may be bank account information, investment (e.g., mutual fund, money market, brokerage) account information and/or cryptocurrency account information. The B2B Cannabis online marketplace needs to keep the seller or grower account profile information private so that buyers or purchasers and/or other sellers or growers do not have access to this information. As identified above, the owner and/or the operator of the B2B Cannabis online marketplace is the only entity that has access to both the buyer and/or seller/grower profile information. The only seller or grower information that may be available to the buyer or purchaser is the seller or grower unique name and/or seller or grower identification value. Thus, in some embodiments, a seller or grower on a seller or grower computing device may be identified only via the seller or grower unique name and/or unique identification during transactions (e.g., purchasing cannabis products).

The B2B Cannabis online marketplace may need to verify the seller or grower is authentic in order to allow the buyer to purchase products on the B2B Cannabis online marketplace. In some embodiments, the seller of grower module 250 may need to verify that the seller or grower has the necessary funds and/or liquidity in order to transact business on the B2B Cannabis online marketplace. In some embodiments, the seller or grower module 250 may include a seller credit module 260 to verify credit worthiness of the seller or grower of the cannabis products. In some embodiments, the credit module 260 may reject seller or growers who do not maintain a specific credit rating threshold and/or do not have a bank or other financial institution that will stand behind them in case the funds or product is not immediately available. In some embodiments, the seller or grower module 250 may include a seller escrow account module or an escrow account link 265 where the seller or grower has to deposit currency and/or product (e.g., images of and documents establishing ownership of product and/or actual cannabis products) in order to verify the seller or grower is able to engage in selling cannabis products, has the cannabis products to sell and/or can engage in transactions in the B2B Cannabis online marketplace. The currency may be fiat currency (e.g., US dollars) and/or cryptocurrency. In some embodiments, the seller or grower may have to deposit $30,000 in currency in order to register with B2B Cannabis online marketplace along with or alternatively may be required to have land ownership or lease documents along with photos and/or videos of the cannabis products that are to be sold. In some cases, the cannabis grower or seller may have to work with the owner of the B2B Cannabis online marketplace and provide cannabis products to the owner so that the owner can verify compliance and/or may have product that the buyer can sample and/or verify is authentic (and/or potent).

In some embodiments, the seller or grower module 250 may include a seller licensing module 270. In some embodiments, the seller licensing module 270 may automatically contact city, county, state, and/or federal licensing agencies to verify that the seller or grower has the proper city, county, state and/or federal requirements for selling and/or distributing cannabis. In some embodiments, if online verification with licensing authorities is not available, the seller licensing module 270 may request that the seller or grower enter and/or upload licensing information and/or certificates to the seller licensing module 270 of the seller or grower module 250 and then the seller licensing module 270 may analyze the entered and/or uploaded information in order to verify the seller or grower meets all licensing requirements. In some embodiments, the seller criminal check module 275 of the seller module 250 may verify that the seller or grower (and any employees thereof) has a clean criminal record by running a background check and/or an FBI background check. In some embodiments, if the seller or grower meets all of the above-identified requirements and positive reports are received from the seller credit module 260, the seller escrow module 265, the seller licensing module 220 and/or the criminal check module 275, then the seller module 250 may authenticate and/or approve the buyer or purchaser as an entity or individual that may engage in transactions on the B2B Cannabis online marketplace.

In some embodiments, the seller module 250 may also include a product interface module 280. In some embodiments, the product interface module 280 may allow the seller to provide information and/or images for the cannabis products that the seller or grower decides to sell. The product interface module 280 may include an interface or entry portal to an online product catalog. In some embodiments, a seller or grower may utilize the product interface module 280 to edit, add and/or delete cannabis products from the online product catalog. In some embodiments, the seller or grower may utilize the product interface module 280 to upload product images and/or videos and/or product descriptions for the cannabis products. In some embodiments, the seller or grower may utilize the product interface module 280 to set prices for the cannabis products they wish to sell to buyers or purchasers. In some embodiments, the seller module 250 may be a mobile computing device software application (mobile app) that communicates and/or interacts with one or more cloud-based computing devices. As described above, the seller module 250 (and other associated modules) may be computer-readable instructions stored in one or more memory devices and executable by one or more processors or controllers in order to provide the functionality described herein.

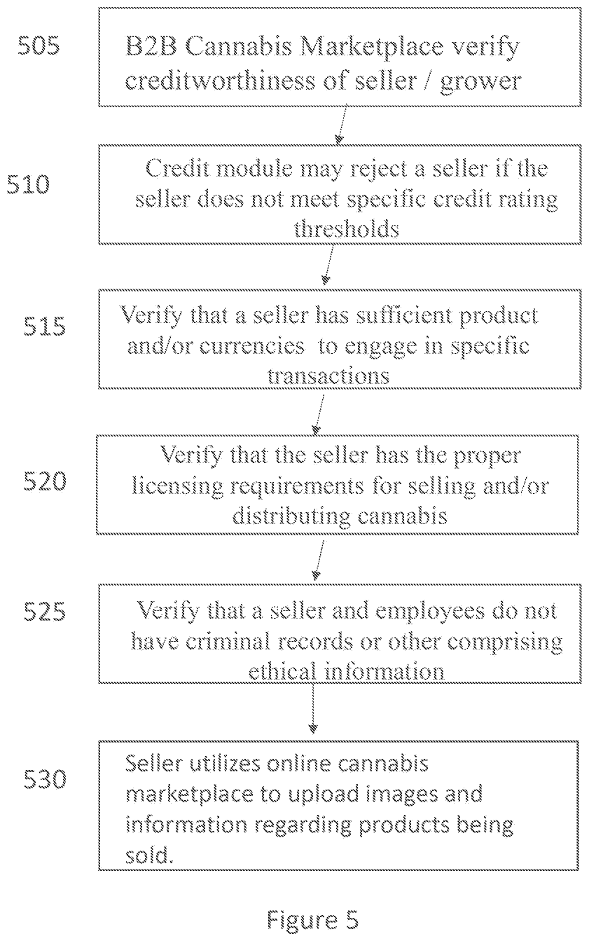

FIG. 5 illustrates a method of cannabis marketplace verifying a seller or grower according to some embodiments. In some embodiments, in step 505, a cannabis online marketplace (e.g., a seller credit module 260) may verify creditworthiness of a seller or grower by checking a credit score of a seller or grower. In some embodiments, in step 510, the credit module 260 may reject the seller if the seller does not meet specific credit rating thresholds or have a bank or financial institution to stand behind the seller. In some embodiments, in step 515, a seller escrow module 265 may verify that a seller has sufficient currencies and/or cannabis or agricultural products to engage in specific transactions. This may occur by the escrow module 265 checking third-party financial institution computing devices for balances and/or lines of credits or verifying that cannabis products are in stock or in physical escrow storage. In some embodiments, in step 520, a seller licensing module 270 may automatically contact city, county, state, and/or federal licensing agencies (through respective and/or associated computing devices) to verify that the seller or grower has the proper city, county, state and/or federal requirements for selling and/or distributing cannabis. In an alternative embodiment, the licensing module 270 may verify uploaded licensing information from the seller in order to verify the buyer or purchaser has the proper licenses and requirement. In some embodiments, in step 525, a criminal check module 225 may verify that a seller or grower (and/or associated employees) do not have criminal records or other comprising ethical information. In some embodiments, in step 530, a seller product interface module 280 may allow a seller to upload images and information regarding products to the B2B online cannabis marketplace. In some embodiments, the seller may utilize the B2B online cannabis marketplace to edit and/or set prices with respect to the uploaded products in the B2B online cannabis marketplace.

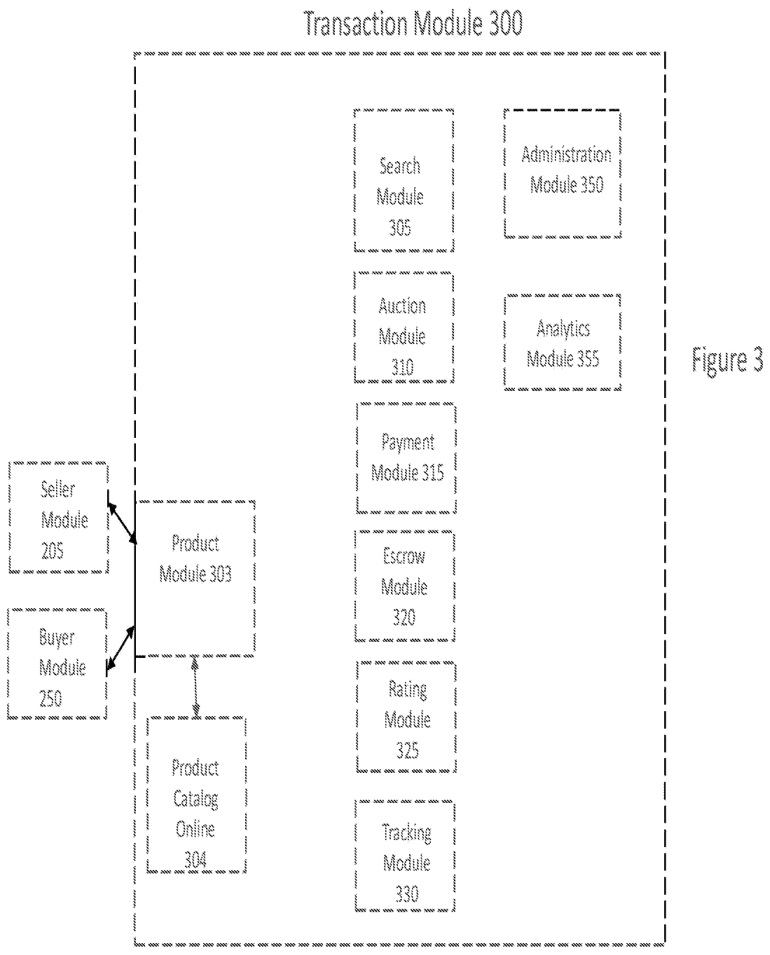

FIG. 3 illustrates a transaction module 300 according to some embodiments. In some embodiments, the transaction module 300 may monitor and enable transactions between buyers and/or sellers of cannabis products. In some embodiments, the transaction module 300 may include a search module 305, an auction module 310, a payment module 315, an escrow module 320, a rating module 325 and/or a tracking module 330. In some embodiments, the transaction module 300 may also include a product module 303 that is the interface to the online cannabis product catalog 304. In some embodiments, the product module 303 may house the different web pages and/or other data forms for all of the cannabis products that are available in the B2B cannabis online marketplace. In other words, the product module 303 may include the product pages for all of the available cannabis products, which includes information about the product as well as images and/or videos related to the cannabis products. In these embodiments, the seller or grower module 250 may upload the available cannabis products, the related image and/or video files, and/or information or parameters related to the available cannabis products to the product module 303 of the transaction module 300 which allows the buyers and/or purchasers to see and/or browse these product offerings. This may be referred to as the online product catalog 304.

In some embodiments, the search module 305 may include a search bar that allows buyers or purchasers to find sellers or growers. In some embodiments, the search module 305 may allow buyers or purchasers to be able to find sellers or growers based on factors and/or parameters such as city, zip code, proximity to buyers or purchasers, product specific characteristics, and/or produce specific names.

In some embodiments, the transaction module 300 may include an auction module 310 to allow sellers or growers to hold an auction to sell their cannabis products. In some embodiments, the seller module 250 may allow the seller or grower to interface and/or interact with the auction module 310 of the transaction module 300 to identify that an auction will be held to sell the seller's cannabis products. In these embodiments, the seller module 250 may input the operational parameters for the cannabis product auction into the auction module 310 in order to allow the purchasers or buyers to know the rules under which the auction may be held. Many different types of auctions may be held including but not limited to highest offer auctions, first buyer auctions, multiple party option auctions, and/or to allow sellers and/or buyers to engage in negotiations for pricing of the cannabis products.

In some embodiments, the transaction module 300 may include a payment module 315 to handle the payment mechanisms for selling and/or purchasing the cannabis products. In some embodiments, the payment module 315 may include a shopping cart where a purchaser or buyer can add cannabis products before purchasing the cannabis products. In some embodiments, the payment module 315 may interface with third-party payment processing systems in order to process the seller's or purchaser's product order and interface with the escrow module 320. In some embodiments, the payment module 315 may accept payment in fiat currencies such as US collars and/or cryptocurrency. The payment module 315 must verify payment before any transaction may be completed.

In some embodiments, the transaction module 300 may include an escrow account module 320 that interfaces with the seller's escrow module 265 and/or the buyer escrow module 215. In these embodiments, the escrow account module 320 may keep track of all the escrow deposits of currency and/or products for all of the purchasers or buyers and/or the sellers and/or growers. Once the transaction has been authorized by the B2B cannabis online marketplace, the B2B cannabis online marketplace may communicate via the escrow account module 320 to have the seller's escrow module 265 transfer the currency to the sellers or growers escrow module 265. In some embodiments, the transfer of funds to the seller or growers account may not occur until the product is received by the purchaser or buyer or alternatively, when the purchased product is shipped to the buyer or purchaser.

In some embodiments, a rating module 325 may allow purchasers or buyers to provide ratings for sellers or growers. Similarly, the rating module 325 may allow sellers or growers to provide ratings for purchasers or buyers. In some embodiments, the rating module 325 may allow any party to rate the other party in the transaction on a scale from 1 to 5, although other rating scales may be utilized. In some embodiments, the rating module 325 may allow any party to include comments about the other party.

However, the rating module 325 may not allow any parties to include addresses of the other parties; to defame the other party, and/or to utilize vulgarities or obscene language with respect to the other party. In some embodiments, the rating module 325 may summarize and/or aggregate ratings for any of the individual parties (e.g., buyers, purchasers, sellers and/or growers) and/or display these to other parties. In some embodiments, the buyer or purchaser module 205 may have a buyer ratings module that interfaces and/or interacts with the rating module 325 and allows buyers or purchasers to rate the sellers and/or growers. In some embodiments, the seller or grower module 250 may have a seller ratings module that interfaces and/or interacts with the rating module 325 to allow sellers and/or growers to rate purchasers and/or buyers.

In some embodiments, the transaction module 300 may include a transportation module 330 to coordinate shipping of the cannabis products from the seller and/or grower to the buyer and/or purchaser. In some embodiments, the transportation module 330 may search for and/or assign vehicles and/or automated devices to deliver the purchased cannabis products to the buyer or purchaser. The transportation module 330 will evaluate the delivery time requested, the location of the stored cannabis product, the vehicles that are in service and/or available for delivery as well as the time of day before assigning a vehicle or device to deliver the purchased cannabis product. Once the vehicle has been assigned and the vehicle or device has picked up the purchased cannabis product, the transportation module 330 may notify (e.g., via push notifications) the buyer and/or the seller that the product is on the way to the buyer or purchaser's delivery address. In some embodiments, the transportation module 330 may provide the buyer or purchaser with an estimated time of delivery. In some embodiments, once the product has arrived at the buyer or purchaser's delivery address, the transportation module 330 may notify the buyer (purchaser) and the seller (grower) that the delivery has been made. In some embodiments, the buyer or purchaser (through the buyer or purchaser module 205) may communicate and/or verify that the product has been delivered and/or is in acceptable condition. If there are issues, the buyer or purchaser (though the buyer or purchaser module 205) may notify that there are problems with the ship and initiate an escalation sequence between the parties. In some embodiments, the transportation module 330 may request or require pictures of the products being delivered and/or an electronic signature from the buyer or purchaser verifying that the shipment has been received and/or is acceptable. Once the transportation module 330 has received the verification from the purchaser or buyer, the transportation module 330 may communicate with the escrow module to release the funds from the buyer (purchaser) to the seller or grower. In some embodiments, the transportation module 330 may also aggregate performance statistic parameters for the shipper, the buyer and/or the seller.

The transaction module 300 may also include an administration module 350 for the owner and/or operator of the B2B cannabis online marketplace in order for the owner and/or operator to ensure acceptable operation of the B2B cannabis online marketplace. The administration module 350 may have a dashboard to allow the owner and/or operator to perform specific actions with respect to the B2B cannabis online marketplace. In some embodiments, purchasers and/or buyers (or sellers or growers) may have low ratings and/or may not be operating according to the guidelines and/or rules of the B2B cannabis online marketplace. In these situations, the owner and/or operator may utilize their computing device to login into the administration module 350 and/or to delete users (e.g., purchasers, buyers, sellers, or growers) from the B2B cannabis online marketplace. The owner and/or operator may also utilize the administration module 350 to accept and/or reject users (e.g., purchasers, buyers, sellers, or growers) who have applied to be part of the B2B cannabis online marketplace but do not meet all of the acceptance criteria. In some embodiments, the administration module 350 may also be utilized by the owner and/or operator to add users and/or to edit specific parameters of users of the B2B cannabis online marketplace.

In some embodiments, the owner and/or operator (through their computing devices) may utilize the administration module 350 to track new orders, existing orders and/or completed orders and/or transactions. In some embodiments, the administration module 350 may also be utilized to verify that the transactions are complete as requested and/or agreed upon. In some embodiments, the owner and/or operator (through their computing devices) may utilize the administration module 350 to edit the seller or grower's product pages to change relevant information with respect to the seller or grower's product pages.

The transaction module 300 may also include an analytics module 355 for the owners and/or operators of the B2B cannabis online marketplace. In some embodiments, the analytics module 355 may provide the owner and/or operators with a window into how different users are performing and/or how their part of the B2B Online Cannabis marketplace operation is performing. For example, the analytics module 355 may generate user analytics to show the numbers of buyers and/or sellers, buyer purchase patterns (timing and/or amount), seller or grower product availability patters (e.g., when harvested and/or amount being sold). As another example, the analytics module 355 may also generate shipment analytics to track how the owner and/or operator's transportation network are operating and/or performing (e.g., availability, on-time delivery, and/or condition of the products). In addition, the analytics module 355 may also generate information and/or parameters to show when purchased products were shipped, when payment was made, whether there were any complaints, etc.). In some embodiments, the analytics module 355 may also generate aggregate statistics for all of the parties in the B2B online cannabis marketplace. In some embodiments, the analytics module 355 may also utilize the aggregate statistics to compare owners or growers against each other or an owner or grower average. In some embodiments, the analytics module 355 may also utilize the aggregate statistics to compare buyers or purchasers against each other or a buyer/purchaser average.

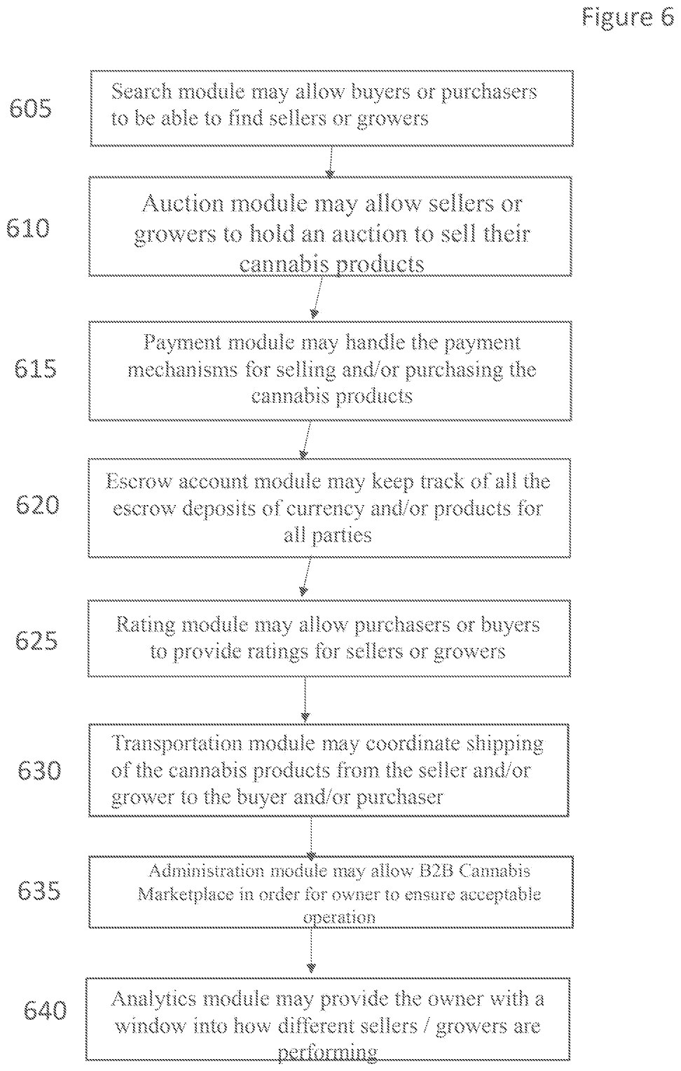

FIG. 6 illustrates a method of operating an online cannabis marketplace according to some embodiments. In some embodiments, a B2B online cannabis marketplace may include a search module and in step 605, the search module 305 may allow buyers or purchasers to be able to find sellers or growers, as described above. In some embodiments, a B2B online cannabis marketplace may include an auction module 310 and in step 610 the auction module may allow sellers or growers to hold an auction to sell their cannabis products. In some embodiments, a B2B online cannabis marketplace may include a payment module 315. In step 615, a payment module 315 may handle the payment mechanisms for selling and/or purchasing the cannabis products. In some embodiments, the payment module 315 may include a shopping cart where a purchaser or buyer can add cannabis products before purchasing the cannabis products. In some embodiments, the B2B online cannabis marketplace may include an escrow account module 320. In some embodiments, in step 620, the escrow account module 320 may keep track of all the escrow deposits of currency and/or products for all of the purchasers or buyers and/or the sellers and/or growers. In some embodiments, the B2B online cannabis marketplace may include a rating module 325. In some embodiments, in step 625, the rating module 325 may allow purchasers or buyers to provide ratings for sellers or growers. In some embodiments, the B2B online cannabis marketplace may include a transportation module 330. In some embodiments, in step 630, the transportation module 330 may coordinate shipping of the cannabis products from the seller and/or grower to the buyer and/or purchaser. In some embodiments, the B2B online cannabis marketplace may include an administration module 350. In some embodiments, in step 635, the administration module 350 may allow for the owner and/or operator of the B2B cannabis online marketplace in order for the owner and/or operator to ensure acceptable operation of the B2B cannabis online marketplace. In some embodiments, the B2B online cannabis marketplace may include an analytics module 355. In some embodiments, in step 640, the analytics module 355 may provide the owner and/or operators with a window into how different users are performing and/or how their part of the B2B Online Cannabis marketplace operation is performing. Although the description here describes a cannabis B2B online marketplace, the specification and claimed subject matter also applies to other regulated medical products and agricultural products, such as tobacco, hemp, gummies, or other products under FDA control.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step. In addition, one or more of the devices described herein may transform data, physical devices, and/or representations of physical devices from one form to another. For example, one or more of the devices recited herein may receive image data of a sample to be transformed, transform the image data, output a result of the transformation to determine a 3D process, use the result of the transformation to perform the 3D process, and store the result of the transformation to produce an output image of the sample. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. An online business-to-business (B2B) cannabis marketplace comprising:
a search module to allow cannabis buyers to be able to find cannabis sellers or growers;
the auction module to allow cannabis sellers to hold an auction to sell the seller's cannabis products;
a payment module to handle payment tracking and payment processing for the seller's cannabis products;
an escrow account module to keep track of escrow deposits of currency by sellers or buyers and/or deposits of cannabis products by sellers in the online B2B cannabis marketplace;
a rating module to allow the cannabis buyers to provide ratings for the cannabis sellers;
a transportation module to coordinate shipping of purchased cannabis products from the cannabis seller to the cannabis buyer;
an administration module to allow for the operator of the online B2B cannabis marketplace in order for the operator to ensure acceptable operation of the marketplace; and
an analytics module to provide the owner of the online B2B cannabis marketplace with data and/or reports with respect to how different cannabis sellers or cannabis buyers are performing and also to provide the cannabis sellers or cannabis buyers with data and/or reports on how the cannabis sellers or cannabis buyers operation is performing.

2. A method of operating an online business-to-business (B2B) cannabis marketplace, comprising:
verifying creditworthiness of a cannabis buyer by checking a credit score of the cannabis buyer by determining whether the cannabis buyer meets specific credit rating thresholds;
verifying that a cannabis buyer has sufficient currencies in their bank accounts to engage in specific transactions by checking one or more account balances in one or more financial institution's computing devices;
automatically communicating with city, county, state, or federal licensing agencies through respective city, county, state or federal agencies computing devices) to verify that the cannabis buyer has proper city, county, state or federal for selling and/or distributing cannabis products; and
verifying that a cannabis buyer, and associated employees, do not have criminal records or other comprising ethical information by contacting third party computing devices.

3. A method of operating an online business-to-business (B2B) cannabis marketplace, comprising:
verify creditworthiness of a cannabis seller by checking a credit score of the cannabis seller;
verify that a cannabis seller has sufficient cannabis products to engage in specific transactions by checking with third-party computing devices;
communicating city, county, state, or federal licensing agencies through respective city, county, state or federal computing devices to verify that the buyer or purchaser has sufficient city, county, state or federal licenses for selling and/or distributing cannabis products;
verifying that the cannabis seller and associated employees do not have criminal records or other comprising ethical information by communicating with third-party computing devices; and
utilizing a seller product interface module to upload cannabis product images and information regarding to the online B2B online cannabis marketplace.
